(19) United States
(12) Patent Application Publication
(10) Pub. No.: US 2005/0044061 A1
(43) Pub. Date: Feb. 24, 2005

(54) Method and system for providing interactive business directory services

(76) Inventor: Jason L. Klemow, Gaithersburg, MD (US)

Correspondence Address: DITTHAVONG & CARLSON, P.C., Suite A, 10507 Braddock Road, Fairfax, VA, 22032, US

(21) Appl. No.: 10/924,169

(22) Filed: Aug. 23, 2004

Related U.S. Application Data
(60) Provisional application No. 60/497,038, filed on Aug. 22, 2003.

(51) Int. Cl. G06F 7/00

(52) U.S. Cl. 707/1

(57) ABSTRACT

An approach for providing an electronic business directory (e.g., Digital Yellow Pages) with interactive services over an electronic consumer device. The device includes means for retrieving information from a remote database storing business directory listings and advertisements, wherein the remote database is accessed over a data network (e.g., the global Internet) and is capable of being modified directly by a business listed in the directory or by an agent of the business. According to one embodiment of the present invention, the device also includes a touch screen display for displaying the information and for receiving input relating to the retrieved information associated with the interactive services.

### RELATED APPLICATIONS

This application is related to, and claims the benefit of the earlier filing date under 35 U.S.C. §119(e) of, U.S. Provisional Patent Application (Ser. No. 60/497,038) filed Aug. 22, 2003 (Attorney Docket: 01041-1002), entitled “Method and System for Providing Interactive Business Directory Services”; the entirety of which is incorporated herein by reference.

### FIELD OF THE INVENTION

The present invention relates to electronic commerce and more particularly to interactive electronic directory and advertisements.

### BACKGROUND OF THE INVENTION

Traditionally, business directories, such as Yellow Pages, consist of a print publication providing a combination of business advertisements and a comprehensive listing of many businesses within a geographic market. Unfortunately, these printed directories confine the users to view information strictly within the users' geographic market. In addition, the cost of publication and distribution are high. Further, the directory information can change quite often, thereby rendering the information stale. Another problem with print publication is that as the number of businesses grow within an area, the size of the publication correspondingly increases, making the book cumbersome to use and stow.

With the popularity of the global Internet and the World Wide Web, online directories have emerged to address some of these issues confronting the printed publications of business directories. Despite availability of online business directories, users continue to use the printed publications because of the convenience afforded by a physical book. For example, users find it is inconvenient to boot up a computer system to obtain a single listing. Moreover, the computer system is typically located in an area of the home that is somewhat secluded (such as a study or home office area), thereby compounding the inconvenience. Further, online providers have limited the users' ability to access information to through the use of personal computers connected to the Internet. Consequently, the user interfaces have been tailored to the personal computers, such that the interface is not generally workable without a mouse and keyboard. Further, the interface is generally unfriendly and non-intuitive.

Furthermore, for both print publications and online providers, businesses traditionally have been limited with respect to their listings content, and advertisement content, as well as being constrained by the services and capabilities of the particular directory service provider.

Therefore, there is a need for an online business directory that is easy to use and readily accessible by the user, while being cost-effective and profitable for the providers of the directories.

### SUMMARY OF THE INVENTION

These and other needs are addressed by the present invention for providing an easy-to-use, intuitive consumer electronic device providing Digital Yellow Pages with interactive services and other dedicated applications, such as an electronic calendar. The device is capable of sending and retrieving information from a remote site (or database). The device can be deployed within a well-traveled location of the home, such as the kitchen. The device, according to exemplary embodiments, has a form and function similar to that of a tablet computer or a personal digital assistance (PDA), and communicates using, in one embodiment, a wireless communications interface. In addition, the device can be wall mounted, and removed for mobile access throughout the home. The above approach advantageously stimulates acceptance of online directories, and reduces costs for the directory providers.

According to one aspect of an embodiment of the present invention, a device for supporting on-line interactive services is disclosed. The device includes means for retrieving information from a remote database storing business directory listings and advertisements, wherein the remote database is accessed over a data network and is capable of being modified directly by a business listed in the directory or by an agent of the business. The device also includes a touch screen display for displaying the information and for receiving input relating to the retrieved information associated with the interactive services.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a digital yellow pages system, according to an embodiment of the present invention;

FIG. 2 is a flowchart of a process for storing listings and advertisements in the system of FIG. 1, according to an embodiment of the present invention;

FIG. 3 is a diagram of a consumer electronic device supporting interactive yellow pages, according to an embodiment of the present invention;

FIG. 4A is a diagram of exemplary interactive services supported by a digital yellow pages system of FIG. 1, in accordance with an embodiment of the present invention;

FIG. 4B is a diagram of the consumer electronic device FIG. 3 deployed in a kitchen, according to an embodiment of the present invention;

FIG. 5 is a diagram of a consumer electronic device supporting calendaring, according to an embodiment of the present invention;

FIG. 6 is a diagram of a calendaring system, according to an embodiment of the present invention;

FIG. 7 is a flowchart depicting the Setup of Remote Calendar and Advertisements available for subscriptions actions, according to an embodiment of the present invention;

FIG. 8 is a flowchart depicting the Fetch Remote Calendar and Advertisement actions, according to an embodiment of the present invention;

FIG. 9 is a flowchart depicting the Display Calendar and Advertisement, in accordance with an embodiment of the present invention; and

FIG. 10 is a diagram of a computer system that can be used to implement an embodiment of the present invention.

### DESCRIPTION OF THE PREFERRED EMBODIMENT

A system, method, and software for supporting an interactive directory are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

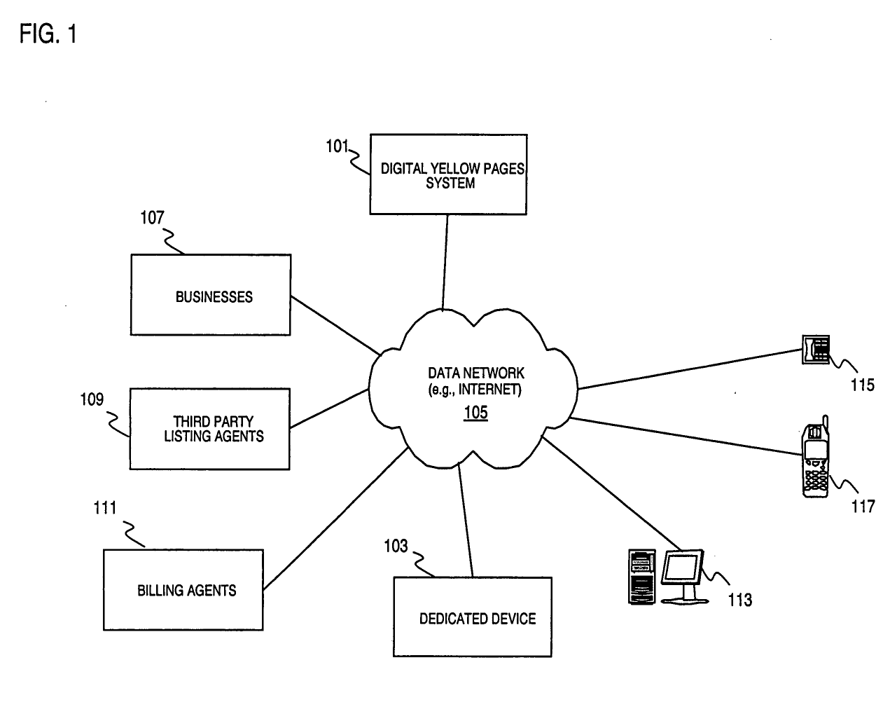

FIG. 1 is a diagram of a digital yellow pages system, according to an embodiment of the present invention. A Digital Yellow Pages system 101 provides an online business directory that is made available to a consumer electronic device 103 over a data network 105. Yellow Pages are listing of business and paid advertisements within a pre-defined geographic area. Listing and paid advertisements are stored within the Digital Yellow Pages system 101 and are provided to the consumer electronic device 103 on an as needed basis.

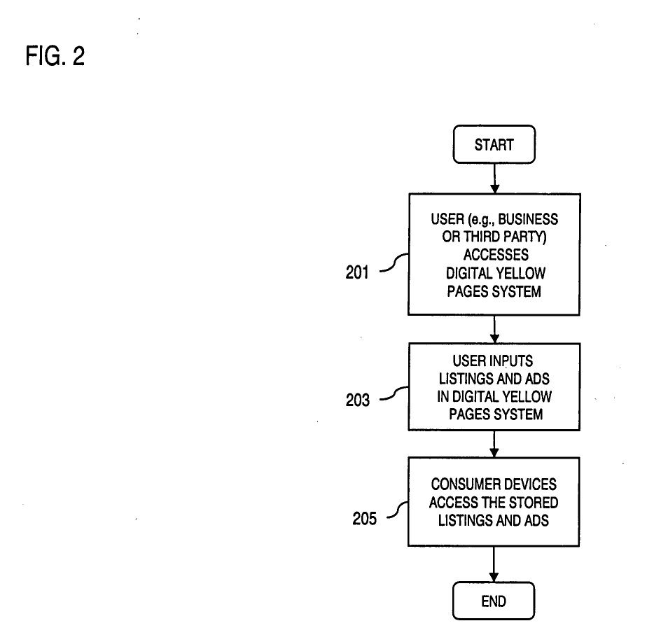

FIG. 2 is a flowchart of a process for storing listings and advertisements in the system of FIG. 1, according to an embodiment of the present invention. The listings and advertisements are stored within the Digital Yellow Pages system 101 directly by business 107 or through third party listing agents 109. Specifically, the user (business 107 or third party listing agent 109) accesses the Digital Yellow Pages system 101 and inputs the listings and advertisements, per steps 201, 203. The stored listings and advertisements are then available for access by the device 103, as in step 205.

In addition to listings and advertisements, businesses 107 may offer services through the Digital Yellow Pages system 101 and require consumers to pay for these services through a Billing Agent 111. Billing Agents 111 can be a credit or debit card provider or a utility company, such as a local telephone company or power company.

While the consumer electronic device 103 may provide access to both local and remote data desired by the consumer, other devices can be used. The business directory application offered by the Digital Yellow Pages system 101 can be accessed through personal computers 113 located, for example on a home network or via an Internet connection, telephones 115 with touch-pad and voice requests, or via cellular phones 117 using touch-pad, voice or dedicated cellular phone applications.

According to one embodiment of the present invention, the Digital Yellow Pages system 101 supports a managed service, wherein the business 107 can manage its listing, advertisement, and interactive services directly online. The system 101 can also involve the use of a sales force, whereby individual sales people manages the listings and advertisements of multiple business and can manage the interactive services directly or indirectly, and by the use of third party listing agents 109, who manage multiple information on behalf of the businesses 107.

Each device 103 is uniquely identifiable, such that advertisement usage information can be collected by geographic zone and key parameters and quantified to assist advertisers. It is noted that the collection and the quantification of the advertisement information can be effected such that the consumers are alerted of their privacy rights and other applicable laws.

It is contemplated that the dedicated device 103 can be extended to be the nucleus of all home networking products; for example, Home Gateway Controller for Controls and Automation, Security Monitoring, and Digital Radio, iTV—(New dedicated channels and Video On Demand). The device 103 may also supports standard PC type applications, such as, Internet browsing, email, Short Message Service/Instant Messaging (SMS/IM), and text to speech.

Furthermore, in addition to the Digital Yellow Pages application, the consumer electronic device 103 can support an electronic calendar (as more fully described later) as well as other dedicated applications (e.g., Address Book, To Do Lists, and Information Delivery). The information delivery can include any type of content, such as music, news, weather, traffic, local events, and other informational programming.

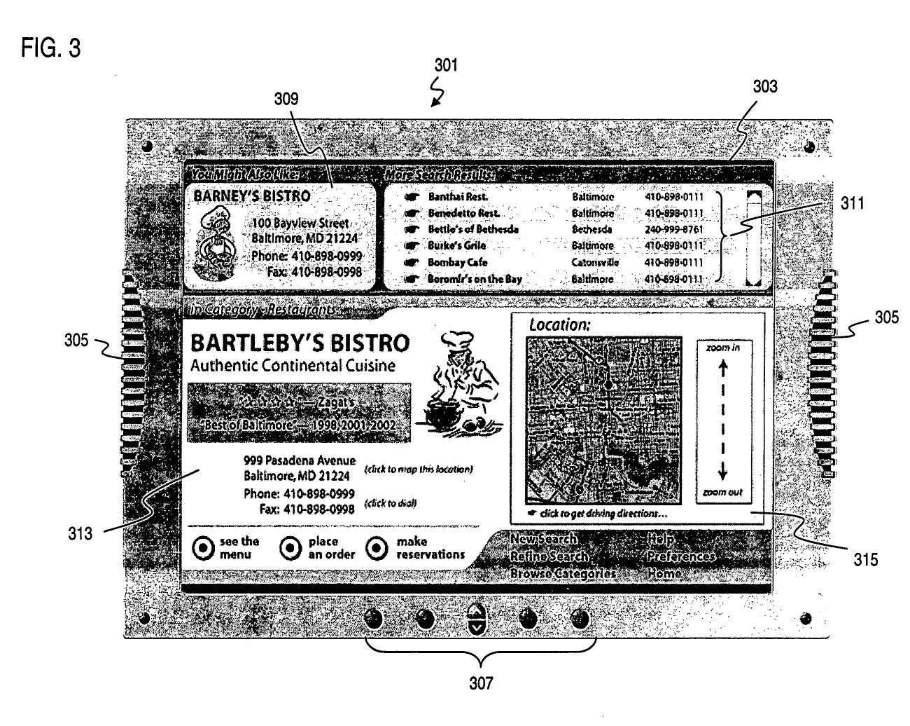

FIG. 3 is a diagram of a consumer electronic device supporting interactive yellow pages, according to an embodiment of the present invention. By way of example, the consumer electronic device 301 has three primary components: a display screen 303, speakers 305 and control buttons 307 for various functions, such as power, volume and one-click buttons to primary applications. Other attributes (not shown) can include an embedded telephone, interfaces, such as, infrared, USB (Universal Serial Bus), Firewire, Ethernet for updating and connecting to other devices.

The Digital Yellow Pages application, resident on the device 301, can include a full business listings targeted for the local geographic market with enhanced advertisement capabilities, as well as new interactive features. The enhanced advertisement capabilities, for instance, include the following: rich display ads, Video on Demand, and deeper and updateable information (such as, Menus, Services, and Hours). The interactive features also has a search function with the capability of serving up, premium listings to move business ads to top of listing results during searches, context sensitive advertisements for related services, online ordering with or without payment capabilities, and a capability to provide businesses a way to offer specials to extremely targeted markets, similar to direct coupon mailers, for example.

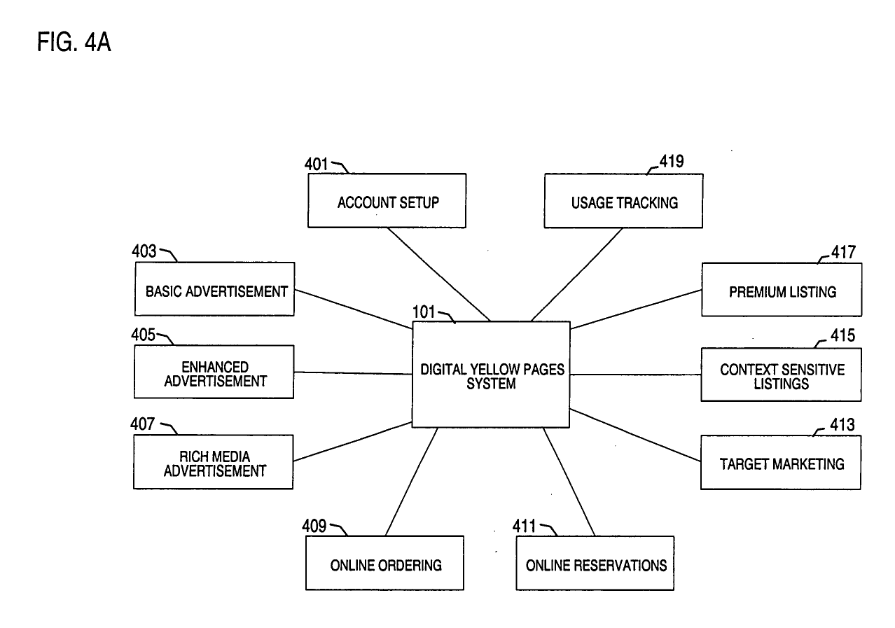

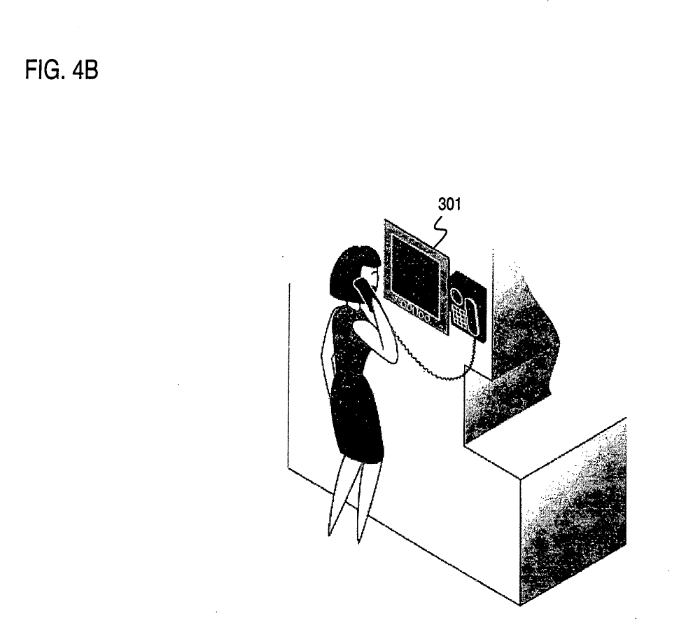

FIG. 4A shows a diagram of exemplary interactive services supported by the digital yellow pages system of FIG. 1, in accordance with an embodiment of the present invention. The system 101 can support an Account Setup module 401, which enables a System Administrator to establish accounts and set available options. A Basic Advertisements module 403 allows a business to input the minimum advertisement information. In addition, an Enhanced Advertisement module 405 is provided to permit businesses to provide additional information based on type of business; for example, menus for restaurants. The system 101 also includes a Rich Media Advertisement module 407, whereby a business has the capability to add interactive information, including video, vector graphics, animation, audio, and other interactivity based advertising. An Online Ordering module 409 is supported by the system 101, enabling a business to accept orders online; for example, restaurant take-out orders can be readily handled. The online ordering may contain options for online payment. Further, an Online Reservations module 411 may be implemented by the system 101 to accept online reservations for a business.

The Digital Yellow Pages system 101 can also possess a Target Marketing module 413 to provide a business with the functionality to display different advertisements based on key parameters; for example, where a user is within a zip code or a certain distance from the business. A Context Sensitive Listing module 415 can permit businesses to display advertisements based on search key words or associated advertisement categories. For example, a car rental listing can be displayed when hotel categories are displayed. The system 101 can additionally supply a Premium Listing module 417 to enable a business to determine when to display advertisement as well as prominence of advertisement based on key parameters including advertisement costs. A Usage Tracking module 419 is supplied, whereby a business can view system statistics with respect to their category and their specific advertisements.

Returning the example of FIG. 3, the device 301 can display any combination of listings and advertisements. The exemplary display 303 provides a small premium advertisement 309, a listing of businesses 311, and a large premium advertisement 313. The large premium advertisement 313 can include on-screen navigation links for interactive service requests. Overall Digital Yellow Pages navigation buttons are also supplied for new and refine searches, browsing, preferences, and help navigation links. In addition, the display 303 can show a map 315 corresponding to the physical address of the selected business listing.

The input to the device 301, in an exemplary embodiment, can include a touch screen, keyboard, or voice activation. The voice activation enables a hands free capability, while the user performs other tasks. The device 301 can send and retrieve information from a remote site by connecting over a network (e.g., Internet 105) using any one of a number or a combination of communication protocols, including wireless, cellular, satellite, broadband through cable, broadband through Digital Subscriber Line (DSL), telephone, or direct Internet connections, such as a T1 line. Preferably, the home communication protocol is wireless broadband.

The device 301 can also include telephony services for example, Voice over IP (Internet Protocol), cellular, or direct wired connections. With telephony services, additional services can be made available, including the ability to direct dial any telephone number shown on the device 301 from the Digital Yellow Pages, Address Book, or from the other telephone directories.

FIG. 4B is a diagram of the consumer electronic device FIG. 3 deployed in a kitchen, according to an embodiment of the present invention. In a typical household, the kitchen provides a main gathering spot, serving as a hub of activity in today's lifestyles. Therefore, the electronic consumer device 301 can be implemented in this hotbed of household activities, and made accessible to all family members, both as a productivity tool as well as an entertainment source.

The kitchen area has evolved beyond merely being a place to prepare meals, to an area where information and entertainment can be obtained. Notably, household items that are not directly related to the preparation of meals are calendars, address books, local restaurant menus, To Do lists, residential telephone directories and business telephone directories with advertisements. Residential telephone directories are commonly known as White Pages and Business Telephone Directories are commonly known as Yellow Pages.

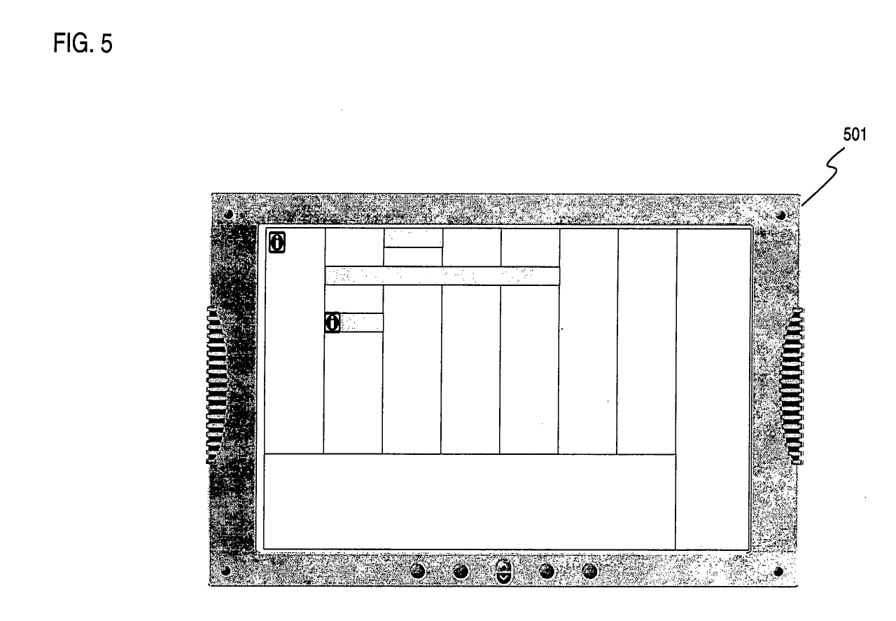

As mentioned previously, in addition the business directory application, the device 301 can support electronic calendaring (as described with respect to FIGS. 5-9), such that users and businesses can schedule appointments through a shared calendar. FIG. 5 is a diagram of a consumer electronic device 301 supporting an electronic calendar 501.

Calendars provide an indispensable tool for effective organization, both in business and personal applications. Electronic calendars have gain significant headway in supplanting paper based calendars, in that electronic calendars can be readily modified and electronically distributed. Given the popularity of the Web, calendaring over the Internet has received increasing attention. For example, many organizations have begun to utilize calendars over the Web to track events and provide scheduling, such that their membership is abreast of the activities and events of the organizations.

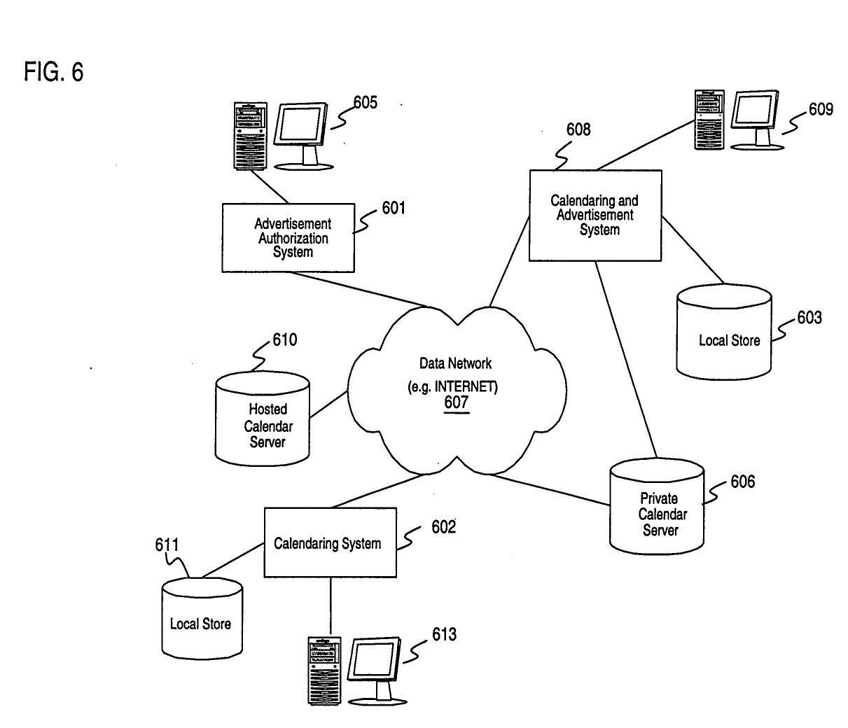

FIG. 6 is a diagram of a calendaring and advertisement system, according to an embodiment of the present invention. A calendaring and advertisement system 608 provides, in an exemplary embodiment, a capability to create and publish calendars with embedded advertisements. The calendaring and advertisement system 608 has connectivity to a data network 607, which can be a public network such as the global Internet. The calendaring information and advertisements can be published to a calendar server. Publishers may maintain their own calendar servers 606 or utilize a hosted calendar server 610. Calendars with embedded advertisements are created by the calendar publishers 609 to record events and advertisements relevant to the respective publishers, and controlled, in one exemplary embodiment, by an administrator host 605. The advertisement and authorization system 601 permits multiple calendar publishers 609 to include calendar advertisements with their calendar. for subscribing of their “remote” calendars over the data network 607.

It is recognized that users (consumers) want to track common events affecting, for example, their households. Such events, for instance, include school schedules, sport practice and game times, after school activities, major holidays, and other community events. Traditionally, the majority of these calendars is pre-set and is not scheduled.

The calendaring system 602 which exists as calendar software resident on the hosts 613 (one of which is shown) can support the above needs of these users. The calendar software can permit viewing more than once calendar at a time based on knowledge of the calendar address. With the calendar software, the users can create and manage multiple calendars in local storage 611.

It is noted that users frequently view their calendars, and thus, usability an important consideration. For example, when the calendar application starts up, the time period that the user has selected as the default view is displayed. The calendar software also supports quick return to the current (today) schedule quickly, such as through a one-click mechanism. Further, the previous and next time period features need to respond quickly to user input.

Further, the calendar software provides access control tools, which can be built into the user interface so that multiple users can use the same device, while each user retain full control over who sees the individual entries or calendars. For example, within a family, “child” accounts can be established apart from an associated “guardian” accounts, wherein the guardian accounts has full access, limited access, or no access depending on how the guardians configure the accounts. The calendar software permits use of an access control list with functions such as insert, browse, and delete members of the list. The guardian accounts can restrict the users who can insert requests into the child accounts; this concept can also be applied to business calendars, merged calendars, and online calendars.

In addition to local calendars storage, the user tool can interact with remote calendars across the Internet 607, adding both local and remote calendars to the user's calendar list.

Moreover, the calendar software can schedule and deposit calendar entries across multiple vendors, supporting multiple languages and character sets (i.e., charsets). The calendar software can also support the exchange of contact information.

In addition to calendaring, the calendar software can also assist the user with scheduling. That is, scheduling operations allow for checking and aligning of appointments to other calendars automatically by checking their free time.

The calendar system 602 as calendar software resident on the hosts 613 and the calendaring servers 606 and 610, according to one embodiment of the present invention, employ an Internet-based protocol, such as the Calendar Access Protocol (CAP), to share calendar information. CAP is detailed in the Internet Engineering Task Force (IETF) Internet Draft dated February 2003 and entitled, “Calendar Access Protocol (CAP)”; the entirety is incorporated herein by reference. Terminologies and concepts relating to calendaring are described in IETF Request for Comment (RFC) 3283, entitled “Guide to Internet Calendaring”; RFC 2445, entitled “Internet Calendaring and Scheduling Core Object Specification (iCalendar),” RFC 2446, entitled “iCalendar Transport-Independent Interoperability Protocol (iTIP),” and RFC 2447, entitled “iCalendar Message-Based Interoperability Protocol (iMP)”; the entireties of which are incorporated herein by reference.

In addition, the calendaring system 602 obtains advertisements from publishers 609, who seek to advertise on the calendars. In is noted that the advertising and authorization system 601 can support authorization of embedding the advertisements into the calendars. Under one scenario, the advertisements are linked or correlated to the particular events specified by a specific calendar of a publisher, in which the advertisements are embedded into the calendars. The advertising and authorization system 601 can provide access to users on the hosts 613 to the embedded advertisements. The advertisements can include any type of visual or aural information (e.g., icons, images, photos, and/or sounds) that are tied to a calendar or to a calendar event. The advertising and authorization system 601 and the calendaring system 602 ensure that only authorized advertisements with the advertisement timeframe may be viewed within the hosts 613. The advertisements are displayed on the end-user Calendars Views; such views can include Monthly, Weekly, and Daily Views, respectively.

Additionally, the calendar software supports synchronization o,f specific items within a calendar and across calendars, interfacing with such tools as Palm® Pilot, Microsoft® Outlook, and other popular calendaring tools as well as e-mail based tools; for example, importing and exporting calendaring information across a variety of platforms (e.g., Apple® iCal calendars). Storage of the calendar data is largely transparent to the user. A Personal Digital Assistant (PDA) user, for example, is aware of two calendars each being synchronized. In some cases, the user has knowledge that there is a remote storage; other times, the user simply views the synchronization process as a backup or “logging in” process.

Further, the users can login in order to invite or search other calendars. Adding an entry on a calendar that belongs to the user appears as the same operation as when the user requests a scheduling entry with another calendar, with the exception when the user does not have permission to book the appointment.

To enable multiple users to subscribe and view to users own calendars, the calendar system 602 permits the user 613 to store (“publish”) calendars to hosted calendar servers 606, according to an exemplary embodiment, or third party sites, such as .MAC account or to a WebDAV-enabled web hosting account or some other compatible web server.

According to one embodiment of the present invention, the hosts 113 are loaded with a calendar software, which for example, is a stand-alone Microsoft® Windows-based Calendar Software and Address Book Application based on Internet Calendaring standards (e.g., CAP). The calendar permits the users to view multiple calendars at one time; and, each calendar can have multiple events and multiple “To Do's.”

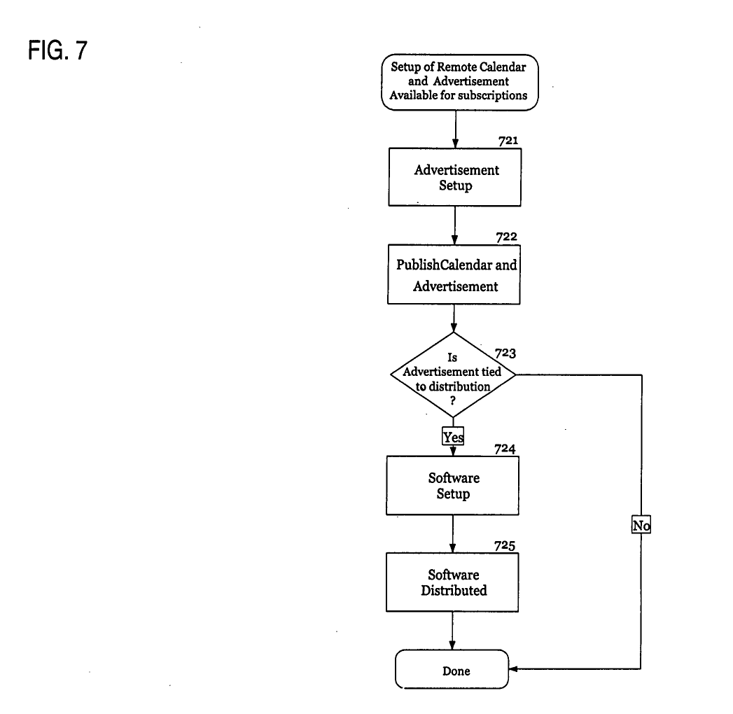

FIG. 7 shows a flowchart for a process for setting up a remote calendar with advertisements for subscription, in accordance with an embodiment of the present invention. The advertising and authorization system 601 supports an advertising setup per step 721, whereby an administrator via the administrator host 605 can create a new advertising event or edit an existing advertising event tied to, for example, a remote calendar. An advertising event, in an exemplary embodiment, specifies identifying information of the remote calendar of the publisher 609, along with details of the advertisement, including authorization, timeframes and graphics.

In step 722, the advertising and authorization system 601 publishes the calendar and advertisement authorization, thereby enabling advertisers to avail their calendar and associated advertisement information to the hosts 613. According to one embodiment of the present invention, the calendar system 602 supports a calendar software and can include a web server (not shown) to provide web-based access to the information.

The advertisements can be tied to the software distribution of the calendar system 602 for an exclusive advertising campaign. Thus, the advertisement and authorization system 601 determines whether the advertisement is in fact tied to the software distribution, per step 723. If so, the calendar software is setup, as in step 724 with a mandatory subscription, to the advertisers' calendar and associated advertisements. Thereafter, the software is published either to a special web site for downloading or to a physical package using distributable media, and the software is distributed, per step 725, in accordance with the advertising campaign.

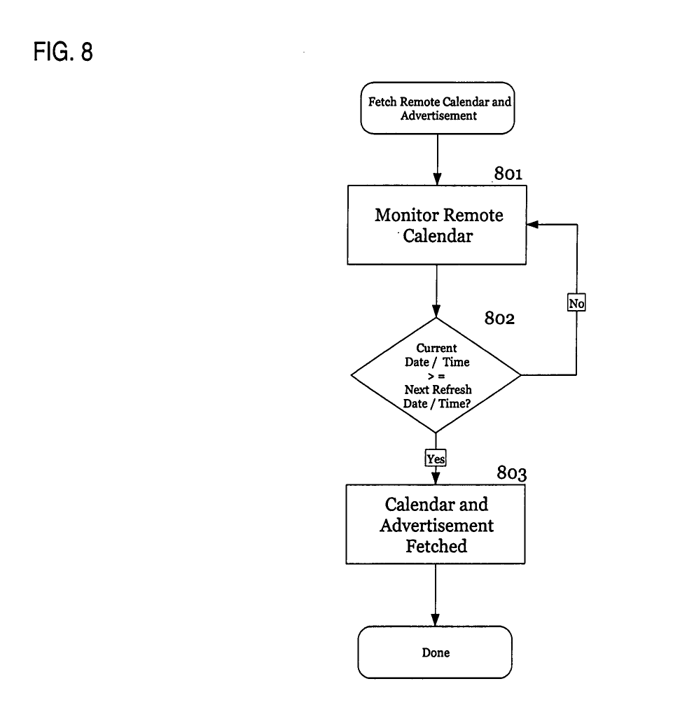

FIG. 8 is a flowchart depicting the Fetch Remote Calendar and Advertisement actions, according to an embodiment of the present invention. The calendar system 602 displays calendars and advertisements stored with a within the local database 611,. The calendar software provides for the fetching of remote calendars and storing the calendar information within the local database 611. These remote calendars are located on calendar servers 606, 610 and accessed over the Internet 607 using standard communication protocols.

To ensure that changes within remote calendars are accounted for, the calendaring system 602 has a Remote Calendar Monitor function to monitor the calendar information of the publishers 609, per step 801. This monitoring can be performed according to a predetermined refresh or update period, i.e., per a Refresh Rate. For instance, in step 802, the calendaring system 602 determines whether the current date/time equals or exceeds the specified next refresh date/time; if not, the system 602 continues to monitor the remote calendars. However, when the user's system date/time is equal to or surpasses the next refresh schedule date/time, a new Calendar and Advertisement is fetched, as in step 803. The fetched calendar and advertisement overwrites the information from the previous calendar and advertisement within the database 611. Alternatively, the calendar and advertisements located on the database 611 is synchronized with the calendar and advertisements located on the remote calendar servers 606, 610 with only the changes being retrieved and updated on the database 611.

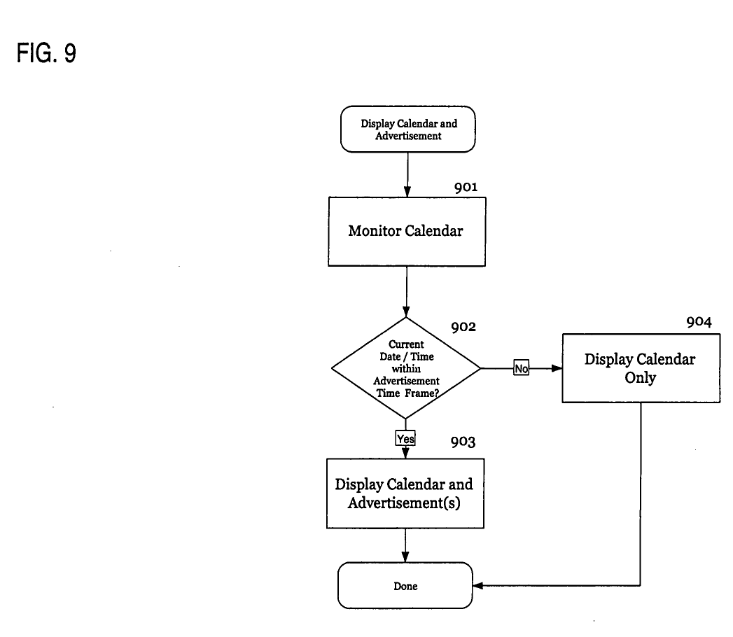

FIG. 9 shows a flowchart depicting the Display Calendar and Advertisement, in accordance with an embodiment of the present invention. The calendar system 602 enables users to create their own calendars or fetch remote calendars for display on the different calendar views. The advertisements associated with the calendars may only be viewed if such advertisements are allowed (or authorized) as controlled by the administrative host 605 on and stored in the advertisement and authorization system 601. Additionally, these advertisements can be controlled such that they are shown according to a configurable schedule. The calendar software provides for authorization by monitoring the various remote calendars, as in step 901, and determining whether the system date/time is within the advertisement time frame (step 902).

If the determination of step 902 is in the affirmative, the advertisements associated with the calendar are displayed, as in step 903, along with the calendar. According to one embodiment of the present invention, a VMEDIA component is written into an .ICS file; as defined in EETF RFC 2445, the file extension of “ics” is to be used to designate a file containing (an arbitrary set of) calendaring and scheduling information consistent with a Multipurpose Internet Mail Extensions (MIME) content type.

The VMEDIA specifies the types of advertisements (e.g., icon, image, photo, sound), and the Uniform Resource Locator (URL) location of each advertisement as stored on the publisher's calendar server 606, web server or on the hosted calendar server 610. If an ICS file contains the VMEDIA component, the monitoring step 901 checks the validity of this component, in which a valid determination results in the advertisements being displayed.

However, if the advertisements are not authorized, only the calendar information (i.e., events) is displayed, per step 904. Alternatively, if more then one calendar and advertisement is authorized for the calendar, then the advertisements are rotated when the calendar view is changed.

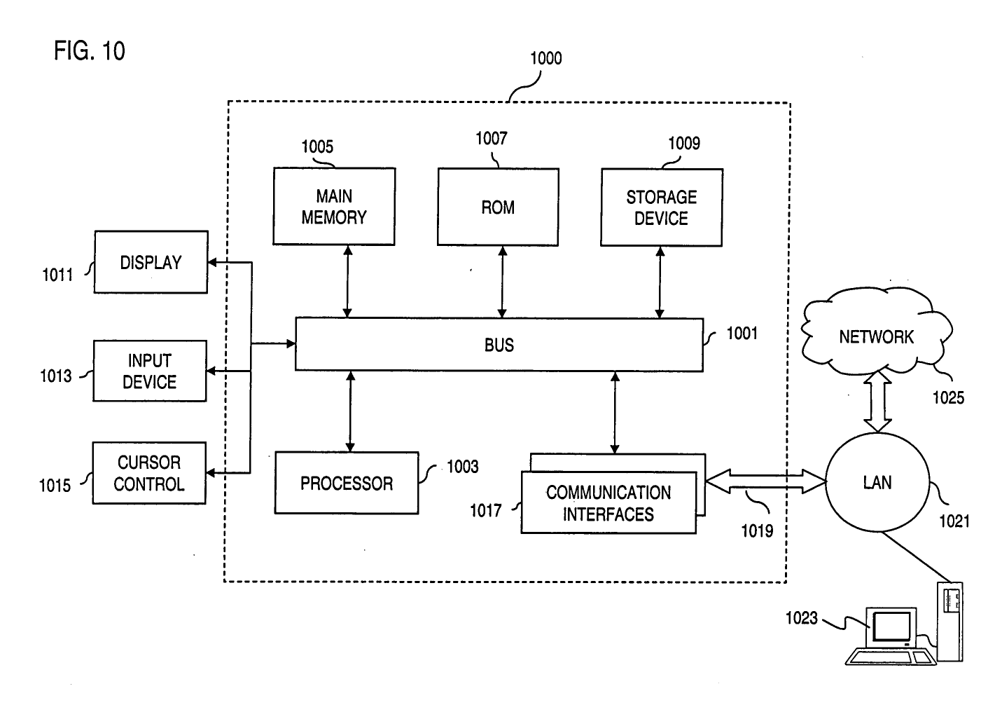

FIG. 10 illustrates a computer system 1000 upon which an embodiment according to the present invention can be implemented. The computer system 1000 includes a bus 1001 or other communication mechanism for communicating information and a processor 1003 coupled to the bus 1001 for processing information. The computer system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to one embodiment of the invention, the functions of the electronic consumer device 103 are provided by the computer system 1000 in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an embodiment of the present invention through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1005 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

Accordingly, the present invention provides a Digital Yellow Pages system with an intuitive, easy-to-use interface via an electronic device for supporting display of the directory listings and advertisements. The device can be deployed in a highly traveled area of a home, such as the kitchen, to permit users to readily access the directory, as well as an electronic calendar.

While the present invention has been described in connection with a number of embodiments and implementations, the present invention is not so limited but covers various obvious modifications and equivalent arrangements, which fall within the purview of the appended claims.

1. A device for supporting on-line interactive services, the device comprising:
means for retrieving information from a remote database storing business directory listings and advertisements, wherein the remote database is accessed over a data network and is capable of being modified directly by a business listed in the directory or by an agent of the business; and
a touch screen display for displaying the information and for receiving input relating to the retrieved information associated with the interactive services.
